(19) United States
(12) Patent Application Publication
(10) Pub. No.: US 2012/0311185 A1
(43) Pub. Date: Dec. 6, 2012

(54) DATA TRANSMISSION BASED ON ADDRESS TRANSLATION

(76) Inventor: Yongbo Li, Beijing (CN)

(21) Appl. No.: 13/486,615

(22) Filed: Jun. 1, 2012

(30) Foreign Application Priority Data
Jun. 2, 2011 (CN) 201110147294.7

(51) Int. Cl. G06F 15/16

(52) U.S. Cl. 709/245

(57) ABSTRACT

Data transmission based on address translation, comprising: sending to a Dynamic Host Configuration Protocol (DHCP) server a request message requesting a public network address by an Network Address Translation (NAT) device; receiving a response message carrying the public network address returned by the DHCP server by the NAT device, performing address translation to said data through said public network address, and sending the translated data to an external network device.

### BACKGROUND

Network Address Translation (NAT) is a process of translating a private network address into a public network address in data so as to realize access to the public network by a private network; besides, by using a small number of public network addresses to represent a large number of private network addresses, exhaustion of available address spaces is alleviated.

In actual NAT application, in order to save address resources and increase the address multiplexing rate, the address translation may also be performed by Network Address Port Translation (NAPT). NAPT allows multiple private network addresses to be mapped onto a same public network address.

### BRIEF DESCRIPTION OF THE DRAWINGS

The accompanying drawings illustrate various examples of various aspects of the present disclosure. It will be appreciated that the illustrated element boundaries (e.g., boxes, groups of boxes, or other shapes) in the figures represent one example of the boundaries. It will be appreciated that in some examples one element may be designed as multiple elements or that multiple elements may be designed as one element. In some examples, an element shown as an internal component of another element may be implemented as an external component and vice versa.

FIG. 1 is a schematic drawing of networking in an application scenario according to an example;

FIG. 2 is a flow chart of an address assigning method provided by the application scenario of FIG. 1;

FIG. 3 is a structural diagram of an NAT device according to an example;

FIG. 4 is a structural diagram of a Dynamic Host Configuration Protocol (DHCP) server according to an example.

### DETAILED DESCRIPTION

As used herein, the term “includes” means includes but not limited to, the term “including” means including but not limited to. The term “based on” means based at least in part on. In addition, the terms “a” and “an” are intended to denote at least one of a particular element.

A certain amount of public network addresses (for example, from several to tens of public network addresses) may be configured in the address pool of a NAT device for the NAT mode and the NAPT mode. The address pools configured on different NAT devices may be fixed on the NAT devices.

The process of network address translation typically comprises:

(1) data sent from an Intranet terminal (for example, its source address is 192.168.1.3) to an external network server (for example, its destination address is 1.1.1.2) pass through an NAT device.

(2) when the NAT device learns that data is to be sent to the external network server, it translates the source address (private network address 192.168.1.3) of the data into the public network address 20.1.1.1, and sends the translated data to the external network server. Moreover, the NAT device also needs to record the mapping relationship between the private network address 192.168.1.3 and the public network address 20.1.1.1 in a network address translation table.

(3) upon data (with a destination address of 20.1.1.1) sent from the external network server to the Intranet terminal arriving at the NAT device, the NAT device checks the contents of the data, looks up for records in the present network address translation table, and replaces the destination address 20.1.1.1 with the private address 192.168.1.3.

The above NAT process is transparent to the Intranet terminal and the external network server, the external network server considers the address of the Intranet terminal to be 20.1.1.1, but it does not know the address 192.168.1.3, so the private network is hidden. Therefore, the NAT function can provide privacy protection for the Intranet terminal in case of realizing access to the external server by the Intranet terminal.

In case of NAPT, assume that three data packets with private network addresses arrive at the NAT device. Data 1 and data 2 come from the same private network address but with different source port numbers, data 1 and data 3 come from different private network addresses but with the same source port number; through the NAPT mapping, the source addresses of data 1, data 2 and data 3 can be translated to the same public network address, while each data is assigned with a different source port number, thus the data can be differentiated. When the response data of each data arrives at the NAT device, the NAT device can differentiate the Intranet terminals to which said response data should be forwarded according to the destination address and destination port number of said response data.

In the case of NAT networking, in order to meet the need of the Intranet terminal, when configuring the size of the address pool, the number of addresses will be configured according to the peak hour needs of the Intranet, otherwise, there will be connection failure of Intranet terminal during peak hours. For example, the address pool 20.1.1.1 to 20.1.1.30 is assigned to Intranet 1, which is fixed on NAT 1; the address pool 20.1.1.31 to 20.1.1.50 is assigned to Intranet 2, which is fixed on NAT 2; the address pool 20.1.1.51 to 20.1.1.100 is assigned to Intranet 3, which is fixed on NAT 3.

However, when configuring the number of addresses according to the peak hour need of the Intranet, there will be idle addresses during non-peak hours, resulting in waste of addresses in the address pool. When a number of Intranets uses the same configuration for the NAT address pool, the waste of addresses may be even more serious.

In the following, certain examples are described in detail with reference to the drawings.

The disclosure relates to data transmission method based on address translation, which is for use in a system comprising an Intranet terminal, an NAT device, a DHCP server and an external network device (e.g. an external server).

In the following, certain examples are described in detail with reference to the drawings.

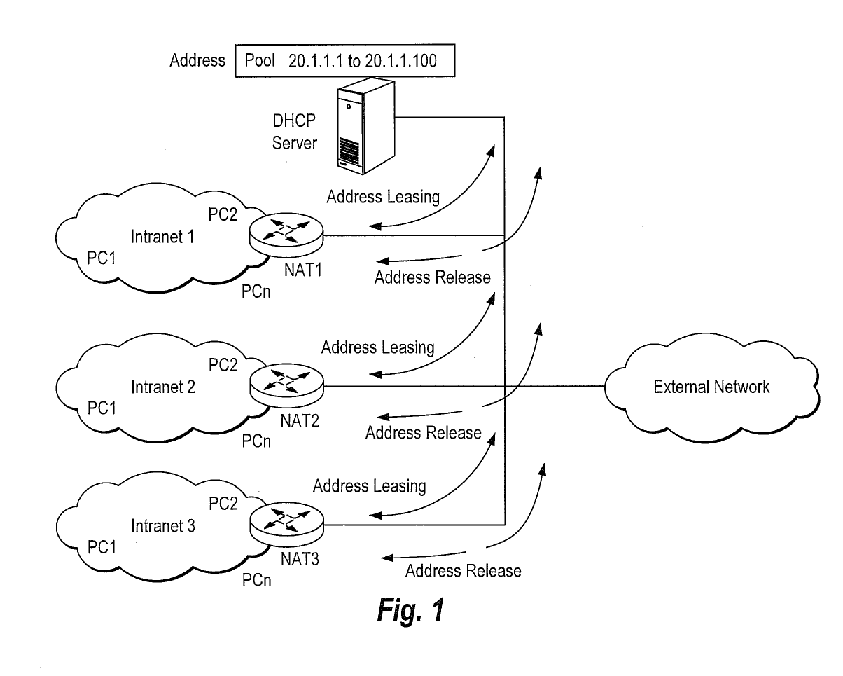

With reference to FIG. 1 first, FIG. 1 is a schematic drawing of networking in an application scenario according to an example. The Intranet terminals in FIG. 1 are the PC devices in Intranet 1, Intranet 2 and Intranet 3; the NAT devices in FIG. 1 are NAT 1, NAT 2, and NAT 3; and the external network device is located in the external network shown in FIG. 1.

In the example, no NAT address pool is configured for each NAT device. But the address pool (e.g. 20.1.1.1 to 20.1.1.100 in FIG. 1) of the public network address is configured on the DHCP server which manages the public address of each NAT device.

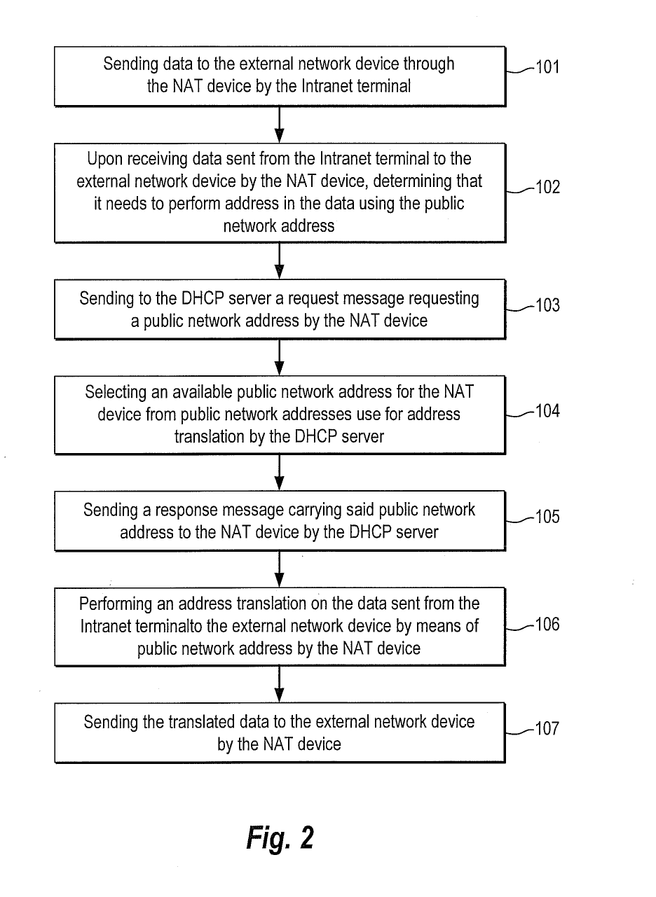

With reference to FIG. 2, FIG. 2 is a flow chart of an address assigning method provided by the application scenario of FIG. 1.

As shown in FIG. 2, said method comprises:

block 101: sending data to the external network device through the NAT device by the Intranet terminal, the source address of said data being the private network address of the Intranet terminal, and the destination address thereof being the address of the external network device;

block 102: upon receiving data sent from the Intranet terminal to the external network device by the NAT device, determining that it needs to perform address translation on the private network address in the data using the public network address;

block 103: sending to the DHCP server a request message (e.g. a DHCP-DISCOVER message) requesting a public network address by the NAT device. In actual application, the address of the DHCP server may be configured on each NAT device, so that the NAT device can send the DHCP-DISCOVER message to the DHCP server in a unicast mode directly through address of the DHCP server.

In the example, no public network address is assigned on the NAT device, so after the NAT device determines that it does not have any available public network address of its own, it needs to request a public network address from the DHCP server through a DHCP protocol.

The process of the NAT device requesting a public network address is similar to the process of a DHCP Relay requesting an address from a DHCP server. The NAT device creates a Loopback interface, configures the corresponding IP address, fills in the giaddr (Gateway IP Address) field of the DHCP-DISCOVER message with said IP address, and sends the DHCP-DISCOVER message to the DHCP server. Said process is similar to the process of the DHCP Relay requesting addresses, so it will not be elaborated any more.

Block 104: selecting an available public network address for the NAT device from public network addresses used for address translation by the DHCP server.

Since the DHCP server has an address pool of the available public network addresses, it can directly select a public network address from the address pool to assign to said NAT device, and the DHCP server cannot assign said public network address to other NAT device until said public network address is released.

Block 105: sending a response message (e.g. a DHCP-OFFER message) carrying said public network address to the NAT device by the DHCP server.

It shall be noted that after receiving the DHCP-OFFER message, the NAT device can also send a DHCP-REQUEST message to the DHCP server in a unicast mode so as to confirm to the DHCP server that it will use the public network address provided in the DHCP-OFFER message; then the DHCP server sends a DHCP-ACK message to the NAT device. This process is similar to the process of the DHCP Relay requesting addresses, so it will not be elaborated any more.

Block 106: performing an address translation on the data sent from the Intranet terminal to the external network device by means of a public network address by the NAT device, i.e. translating the source address in the data from a private network address into a public network address by the NAT device. During the address translation, the NAT device may employ the NAPT mode of translating a number of private network addresses into one public network address, or the mode of translating one private network address into one public network address, but details thereof will be omitted herein.

Block 107: sending the translated data to the external network device by the NAT device, the source address of said translated data being the public network address and the destination address thereof being the address of the external network device.

In the example, if the NAT device no longer needs to perform address translation on said data through said public network address, then it will send a release message (i.e. DHCP-Release message) releasing the public network address to the DHCP server, and the DHCP server will release the corresponding public network address after receiving the release message, so that said public network address can become an available public network address in the address pool and can be assigned to other NAT device in the subsequent address requesting process.

In the example, if, due to various reasons (e.g. power-down of the NAT device), the NAT device cannot release public network addresses normally, the public network addresses assigned to NAT devices can be recovered through the following schemes:

Scheme 1: reducing the address leasing time and using a DHCP renewal mechanism to recover public network addresses.

In order to find out the situation where the public network addresses cannot be recovered due to occurrence of abnormal conditions as early as possible, when selecting an available public network address for the NAT device and setting the leasing time of the public network address, the DHCP server reduces leasing time of the public network address (for example, the leasing time actually assigned to the public network address is 24 hours, then it will be reduced to 30 minutes), so that the NAT device need to send a DHCP-REQUEST message to the DHCP server in a unicast mode within a specified time (e.g. ½ of the releasing time, i.e. 15 minutes) to update the releasing time of the public network address so as to continue using the public network address.

If the DHCP server does not receive the renewal message for the NAT device updating the leasing contract, it will release and recover the public network address upon the leasing time expires, and said public network address will become an available public network address in the address pool, so that it can be assigned to other NAT devices, and the DHCP server will send a DHCP-NAK message to the NAT device to terminate the use of the public network address.

It shall be noted that with respect to the recovered public network address, it can be arranged sequentially at the last position in the address pool, so that it may be assigned at a later time, or said public network address can be placed into the address pool after being cached on the DHCP server for a period of time (i.e. a first predetermined time, e.g. 3 minutes) so as to avoid the problem of public network address confusion caused by said public network address being still used on the NAT device owing to some exceptional circumstances.

Scheme 2: recovering the public network address using an ARP (Address resolution Protocol) detection mechanism.

When the DHCP server and the NAT device are on the same network segment, if the DHCP server does not receive the renewal message (e.g. DHCP-REQUEST message) for the NAT device updating leasing contract within the specified time (i.e. a second predetermined time, e.g. ½ of the leasing time), the DHCP server will send, on its own initiative, an ARP detection message to the NAT device.

If the DHCP server does not receive an ARP response message returned by the NAT device, then it will release and recover said public network address and make it become an available public network address in the address pool, and it will send a DHCP-NAK message to the NAT device to terminate the use of the public network address.

If the DHCP server receives an ARP response message returned by the NAT device, then it means that said public network address is being in use, and if the DHCP server does not receive a renewal message for the NAT device updating the leasing contract after expiration of the leasing time, it will release and recover said public network address and send a DHCP-NAK message to the NAT device to terminate the use of the public network address.

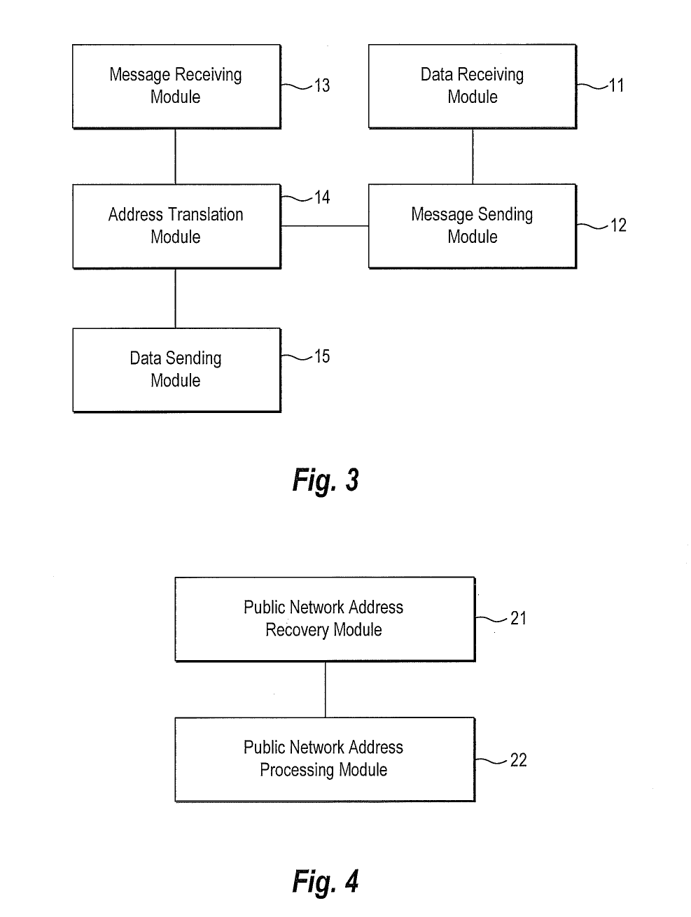

Based on the same concept as that of the above-described method, the disclosure also provides an NAT device for use in a system comprising an Intranet terminal, said NAT device, a DHCP server and an external network device. With the reference to FIG. 3, FIG. 3 is a structural diagram of an NAT device according to an example, wherein said NAT device comprises:

a data receiving module 11 to receive data sent by said Intranet terminal to said external network device;

a message sending module 12 to send a request message for requesting a public network address to said DHCP server;

a message receiving module 13 to receive a response message carrying the public network address returned by said DHCP server;

an address translation module 14 to perform address translation on said data by means of said public network address; and a data sending module 15 to send the translated data to said external network device.

Said message sending module 12 is to send a release message for releasing said public network address to the DHCP server if said address translation module 14 no longer performs address translation on data by means of said public network address.

Said request message comprises a DHCP-DISCOVER message, and said message sending module 12 is to fill in the giaddr field of the DHCP Discover message with the IP address of its own loopback interface when sending a request message for requesting a public network address to said DHCP server.

Wherein, the modules of the device of the example can be integrated together or deployed separately. Said modules can be combined into one module or further divided into multiple sub-modules.

Based on the same concept as that of the above-described method, the disclosure also provides a DHCP server, said DHCP server is for use in a system comprising an Intranet terminal, a NAT device, said DHCP server and an external network device. With the reference to FIG. 4, FIG. 4 is a structural diagram of a DHCP server according to an example. Said DHCP server comprises:

a public network address recovery module 21 to recover a public address released by said NAT device; and

a public network address processing module 22 to arrange sequentially the public network address at the last position in an address pool so that said public network address can be assigned at a later time, or cache the public network address for a first predetermined time before placing it into the address pool.

When said DHCP server and said NAT device are located in the same network segment, said public network recovery module 21 is to send an ARP detection message to said NAT device if it does not receive a renewal message for said NAT device updating the leasing contract within a second predetermined time, and to release said public network address and make it become an available public network address if it does not receive an ARP response message returned by said NAT device.

Wherein, the modules of the device of the example can be integrated together or deployed separately. Said modules can be combined into one module or further divided into multiple sub-modules.

The teachings of this disclosure, the methods described herein and the apparatus, modules and sub-modules may be implemented through hardware, software running on a processor or a combination thereof. In both cases the method and modules are implemented by one or more processors. For example the modules may be implemented as machine readable instructions stored in a memory and executed by a processor, or in hardware as an ASIC (which for the purposes of this disclosure is considered to be a type of processor), or a combination thereof. The disclosure can also be embodied in a software product that is stored in a non-volatile storage medium (such as CD-ROM, USB disc, portable hard drive and so on) and that comprises several instructions to enable a computer device (which can be personal computer, server or network device, etc.) to carry out the method described in the examples of the disclosure.

The drawings are merely schematic drawings of an example, and the modules or flows in the drawings are not necessary essential for carrying out the disclosure.

The modules in the device in the examples can be distributed in the device in the examples according to the descriptions of the example, or they can be changed so as to be in one or more devices that are different from that in the examples. The modules in the above examples can be either combined into one module or further divided into several sub-modules.

The above sequential numbers mentioned are only for facilitating description, but they are not used to represent which example is more advantage.

1. A method for data transmission based on address translation, for use in a system comprising an Intranet terminal, a Network Address Translation (NAT) device, a Dynamic Host Configuration Protocol (DHCP) server and an external network device, wherein said method comprises:
when said NAT device receives data sent by said Intranet terminal to said external network device, sending a request message for requesting a public network address to said DHCP server by said NAT device;
receiving a response message carrying the public network address returned by said DHCP server by said NAT device,
performing address translation on said data by using said public network address, and
sending the translated data to said external network device.

2. The method of claim 1, wherein said method further comprises:
if said NAT device no longer performs address translation on the data by using said public network address, sending a releasing message for releasing said public network address to the DHCP server by said NAT device.

3. The method of claim 2, wherein said method further comprises:
recovering the public network address released by said NAT device by said DHCP server,
arranging sequentially the public network address at the last position in the address pool so that said public network address can be distributed at a later time, or caching the public network address for a first predetermined time period before placing it into the address pool.

4. The method of claim 1, wherein said request message comprises a DHCP-DISCOVER message, and said method further comprises:
when said NAT device sends a request message for requesting a public network address to said DHCP server, filling in the giaddr field of the DHCP Discover message with the IP address of its own loopback interface.

5. The method of claim 1, wherein when said DHCP server and said NAT device are located in the same network segment, if said DHCP server does not receive a renewal message for said NAT device updating the leasing contract within a second predetermined time period, sending an ARP detection message to said NAT device by said DHCP server;
if said DHCP server does not receive an ARP response message returned by said NAT device, releasing said public network address by said DHCP server and making said public network address become an available public network address.

6. A Network Address Translation (NAT) device, for use in a system comprising an Intranet terminal, said NAT device, a Dynamic Host Configuration Protocol (DHCP) server and an external network device, wherein said NAT device comprises:
a data receiving module to receive data sent by said Intranet terminal to said external network device;
a message sending module to send a request message for requesting a public network address to said DHCP server;
a message receiving module to receive a response message carrying the public network address returned by said DHCP server;
an address translation module to perform address translation on said data by means of said public network address; and
a data sending module to send the translated data to said external network device;
said data receiving module, message sending module, message receiving module, address translation module and data sending module being implemented by a processor.

7. The NAT device of claim 6, wherein said message sending module is to send a releasing message for releasing said public network address to the DHCP server if said address translation module no longer performs address translation on the data by using said public network address.

8. The NAT device of claim 6, wherein said request message comprises a DHCP-DISCOVER message, and
said message sending module is to fill in the giaddr field of the DHCP Discover message with the IP address of its own loopback interface when a request message for requesting a public network address is sent to said DHCP server.

9. A DHCP server, for use in a system comprising an Intranet terminal, a NAT device, said DHCP server and an external network device, wherein said DHCP server comprises:
a public network address recovery module to recover a public address released by said NAT device; and
a public network address processing module to arrange sequentially the public network address at the last position in an address pool so that said public network address can be distributed at a later time, or to cache the public network address for a first predetermined time period before placing it into the address pool;
wherein said public network address recovery module and public network address processing module are implemented by a processor.

10. The DHCP server of claim 9, wherein when said DHCP server and said NAT device are located in the same network segment, said public network address recovery module is to send an ARP detection message to said NAT device if said public network address recovery module does not receive a renewal message for said NAT device updating the leasing contract within a second predetermined time, and release said public network address and make said public network address become an available public network address if said public network address recovery module does not receive an ARP response message returned by said NAT device.
